(19) United States
(12) Patent Application Publication
(10) Pub. No.: US 2016/0241733 A1
(43) Pub. Date: Aug. 18, 2016

(54) LED ILLUMINATION UNIFORMITY

(71) Applicant: Xerox Corporation, Norwalk, CT (US)

(72) Inventors: MICHAEL JOHN WILSHER, Letchworth (GB); Sebastián Rodrigo de Echaniz, Middleton (GB)

(21) Appl. No.: 14/625,377

(22) Filed: Feb. 18, 2015

(51) Int. Cl. H04N 1/028

(52) U.S. Cl. CPC H04N 1/0289; H04N 1/0286; H04N 2201/0081

(57) ABSTRACT

An input imaging system and method for adjusting LED light uniformity in an LED array are disclosed. For example, the input imaging system includes an LED array, wherein the LED array is divided into a plurality of different banks of LEDs, wherein a light output of each one of the plurality of different banks of LEDs is independently adjustable, an electrical device for adjusting the light output of the each one of the banks of LEDs coupled to each one of the plurality of different banks of LEDs to achieve the uniform LED light illumination profile, a diffuser coupled to the LED array to scatter the light output towards a document, a lens for collecting the light output that is reflected off of the document and a sensor coupled to the lens to receive the light output that is collected by the lens.

The present disclosure relates generally to improving a light emitting diode (LED) array in an image reading device and, more particularly, to an apparatus and method for adjusting LED light uniformity in an LED array.

### BACKGROUND

Image reading devices or scanners use LED lights to illuminate an image to be read by a charge coupled device (CCD) or contact image sensor (CIS). However, the light intensity profile of the LED array may have a dramatic fall off towards the end of the LED array. For example, LEDs in the middle of the array may have overlapping light with neighboring LEDs on either side. However, LEDs on the end of the LED array may not have the same neighboring LEDs resulting in the dramatic fall off of light intensity compared to the light intensity of the middle of the LED array. In addition, the lens typically has a fall off in light collection efficiency from the center to the edges.

### SUMMARY

According to aspects illustrated herein, there are provided an input imaging system and method for adjusting LED light uniformity in an LED array. One disclosed feature of the embodiments is an input imaging system comprising an LED array, wherein the LED array is divided into a plurality of different banks of LEDs, wherein a light output of each one of the plurality of different banks of LEDs is independently adjustable, an electrical device for adjusting the light output of the each one of the banks of LEDs coupled to each one of the plurality of different banks of LEDs to achieve the uniform LED light illumination profile, a diffuser coupled to the LED array to scatter the light output towards a document, a lens for collecting the light output that is reflected off of the document and a sensor coupled to the lens to receive the light output that is collected by the lens.

Another disclosed feature of the embodiments is a method for adjusting LED light uniformity in an LED array comprising dividing the LED array into a plurality of different LED banks, wherein a light output of each one of the plurality of different banks of LEDs is independently adjustable, measuring, by a processor, the light output for each one of the plurality of different banks of LEDs and adjusting, by the processor, the light output for one or more of the plurality of different banks of LEDs of the LED array to achieve a uniform LED light illumination profile at the sensor.

Another disclosed feature of the embodiments is a non-transitory computer-readable medium having stored thereon a plurality of instructions, the plurality of instructions including instructions, which when executed by a processor, cause the processor to perform operations comprising dividing the LED array into a plurality of different LED banks, wherein a light output of each one of the plurality of different banks of LEDs is independently adjustable, measuring the light output for each one of the plurality of different banks of LEDs and adjusting the light output for one or more of the plurality of different banks of LEDs of the LED array to achieve a uniform LED light illumination profile at the sensor.

### BRIEF DESCRIPTION OF THE DRAWINGS

The teaching of the present disclosure can be readily understood by considering the following detailed description in conjunction with the accompanying drawings, in which:

FIG. 1 illustrates an example block diagram of a system of the present disclosure;

FIG. 2 illustrates an example circuit diagram of the present disclosure

FIG. 3 illustrates an example graph of an uncorrected and corrected light intensity;

FIG. 4 illustrates a second example graph of an uncorrected and corrected light intensity;

FIG. 5 illustrates a flowchart of an example method for adjusting LED light uniformity in an LED array; and

FIG. 6 illustrates a high-level block diagram of a computer suitable for use in performing the functions described herein.

To facilitate understanding, identical reference numerals have been used, where possible, to designate identical elements that are common to the

### DETAILED DESCRIPTION

The present disclosure broadly discloses a method and non-transitory computer-readable medium for adjusting LED light uniformity in an LED array. As discussed above, image reading devices or scanners use LEDs to illuminate an image to be read by a charge coupled device (CCD) or contact image sensor (CIS). However, the light intensity profile of the LED array may have a dramatic fall off towards the end of the LED array. For example, LEDs in the middle of the array may have overlapping light with neighboring LEDs on either side. However, LEDs on the end of the LED array may not have the same neighboring LEDs resulting in the dramatic fall off of light intensity compared to the light intensity of the middle of the LED array. In addition, the fall off of the light collection efficiency of the lens in CCD systems adds additional non uniformity to the light output from the LED illumination. This fall off also affects the signal to noise achievable at the edges.

Some solutions have been to add additional LEDs to the ends of the LED array. However, this adds size and costs to the imaging system. Instead, embodiments of the present disclosure adjust the current delivered to the LEDs at the ends of an LED array to remove the light intensity fall off at the ends of the LED array, while maintaining the overall size profile of the imaging system with fewer components than individual bank control.

Embodiments of the present disclosure also provide finer control of reducing the variation within the LED profile by controlling banks of LEDs. In one embodiment, the symmetry of the LED array may be utilized to organize common banks of LEDs on opposite ends of the LED array to provide finer resolution and control of the light intensity profile of the LED array.

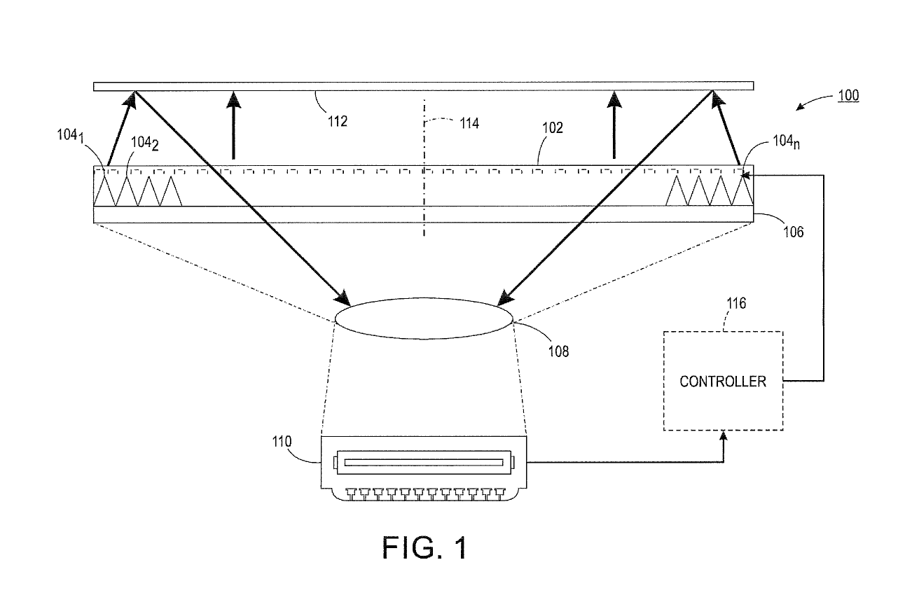

FIG. 1 illustrates an example system 100 of the present disclosure. In one embodiment, the system 100 may be part of an input imaging system for capturing images (e.g., a scanner or imaging device). In one embodiment, the system 100 may include an LED array 102 that includes a plurality of LEDs 104₁ to 104ₙ (also referred to herein individually or collectively as LED(s) 104). In one embodiment, the LED array may include 30 LEDs.

It should be noted that the system 100 is not an image output device (e.g., a printer or a print head that generates the image). For example, the LEDs 104 may require at least 20 milliwatts of power or approximately 1 candela to generate light output. In contrast, the LEDs in an output device may require multiple Watts of power for the LEDs.

In one embodiment, the LEDs 104 generate a light output that is emitted onto a diffuser 106. In one embodiment, the light output may be scattered by the diffuser 106 towards a document 112 that is being scanned. The light may be reflected off of the document 112. A lens 108 may collect the light reflected off of the document 112 and focused to a sensor 110. The sensor 110 may receive the light collected by the lens 108. In one embodiment, the sensor may be a charged coupled device (CCD) or a contact image sensor (CIS). In one embodiment, the lens may be a single lens and a CCD or a Selfoc® lens and a CIS comprising an array of lenslets for each one of the LEDs 104.

As discussed above, the LEDs 104 at the end of the LED array 102 (e.g., LED 104₁ and LED 104ₙ) do not have two adjacent LEDs 104 and, thus, have less overlapping light output from neighboring LEDs 104. As a result, the LEDs 104 at the end of the LED array 102 may have a different light intensity than the other LEDs 104 within the LED array 102. The different light intensities may lead to a non-uniform light intensity profile where the light intensity received by the sensor 110 from the ends of the LED array 102 falls off drastically. This can lead to a lower signal to noise ratio at the edges of the scanned image or exceed the calibration correction range.

However, if the light intensity profile of the LED array 102 is uniform across the length of the LED array 102, then the light intensity read by the sensor 110 may have a low signal to noise ratio (SNR). The low SNR may lead to a lower quality of the scanned image. In one embodiment, uniformity may be defined as having the light intensity value of each LED 104 be within a certain threshold (e.g., above or below) a desired light intensity level or an average light intensity level. For example, uniformity may be defined as being within 1.0 candela of an average light intensity of the entire LED array 102.

In one embodiment, a uniform light intensity profile of the LED array 102 may be achieved via an adjustment mechanism (broadly an electrical circuit or device). In one embodiment, the adjustment mechanism may be a fixed mechanism that is fixed by a modification to a circuit of the LED array 102. In another embodiment, the adjustment mechanism may be a dynamic mechanism that is controlled by an optional controller 116 (broadly an electrical circuit or device). As a result, either via the fixed mechanism or the dynamic mechanism, a light output of one or more LEDs 104 of the LED array 102 may be adjusted to achieve a uniform light intensity profile.

For example, the light output of the one or more LEDs 104₁ and 104ₙ at the ends of the LED array 102 may be increased to reduce the fall off at the ends of the light intensity profile. In addition, other LEDs 104 within the LED array 102 may also be adjusted to reduce the light output to achieve a uniform light intensity profile, related to other effects like the lens fall off, as discussed below.

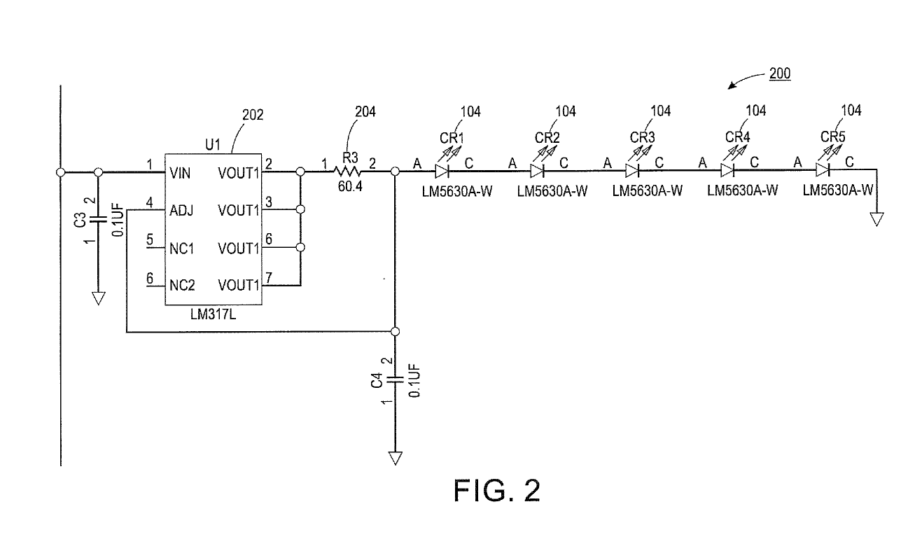

FIG. 2 illustrates a circuit 200 that illustrates one example of a fixed mechanism for adjusting the light output of the LEDs 104. In one embodiment, the circuit 200 may include a controller 202, a current resistor 204 (broadly an electrical circuit or device) and one or more LEDs 104 connected in series. In one embodiment, a value of the current resistor 204 may be based upon a pre-measured adjustment to a light output of the LEDs 104 required to achieve the uniform light output. For example, an average light output of the LED array 102 may be measured and a difference between the average light output of the LED array 102 and the light output of the LEDs 104, or bank of LEDs 104, may determine the amount of resistance needed to adjust a current delivered to the LEDs 104 to correspond to the difference in the light output.

Referring back to FIG. 1, the dynamic mechanism may be implemented via a hardware controller 116 (broadly an electrical circuit or device) that includes a processor. In one embodiment, the controller 116 may control an amount of current that is delivered to each one of the LEDs 104 to adjust a light output of each one of the LEDs 104, or each bank of LEDs 104, based upon the amount of light received by the sensor 110. For example, the sensor 110 may be in communication with the controller 116 and the controller 116 may be in communication with the circuitry of the LED array 102 to control the amount of current delivered to the LEDs 104. In one embodiment, current may be dynamically changed between each scan as needed to achieve a uniform light intensity profile. The amount of adjustment needed may be determined as discussed above with reference to the fixed mechanism. However, the adjustment may be determined by the controller 116 automatically on the fly rather than requiring a pre-measured adjustment.

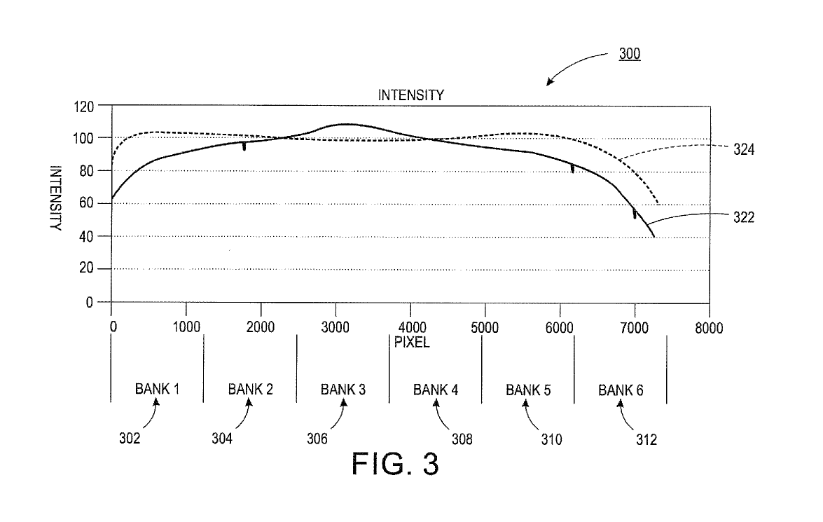

FIG. 3 illustrates an example graph 300 of an unadjusted light intensity profile 322 and an adjusted light intensity profile 324. In one embodiment, the LEDs 104 may be divided into a plurality of different banks of LEDs 302-312. In one embodiment, each one of the plurality of different banks of LEDs 302-312 may include different groups of LEDs 104 from the LED array 102.

In one embodiment, each one of the banks of LEDs 302-312 may have a light output adjusted via the fixed mechanism or the dynamic mechanism. For example, each bank of LEDs 302-312 may be wired via the circuit 200 illustrated in FIG. 2. In addition, each bank of LEDs 302-312 may have a different value for the current resistor 204 based upon a difference of the light output of the bank of LEDs 302-312 compared to an average light output of the LED array 102. For example, the bank 1 302 and bank 6 312 may have a current resistor 204 to increase the current to increase the light output to raise the light intensity values, as shown by the change between the unadjusted light intensity profile 322 and the adjusted light intensity profile 324. In addition, the bank 3 306 may have a different current resistor 204 to decrease the current to decrease the light output to lower the light intensity values, as shown by change between the unadjusted light intensity profile 322 and the adjusted light intensity profile 324.

In another embodiment, the dynamic mechanism may operate by having the controller 116 receives the light intensity values that are read by the sensor 110. The controller 116 may then determine the adjustment required (e.g., either raising or lowering the current to an LED bank 302-312 to either increase the light output or decrease the light output). The controller 116 may then control the current delivered to banks of LEDs 302-312 in accordance with the adjustment that is determined.

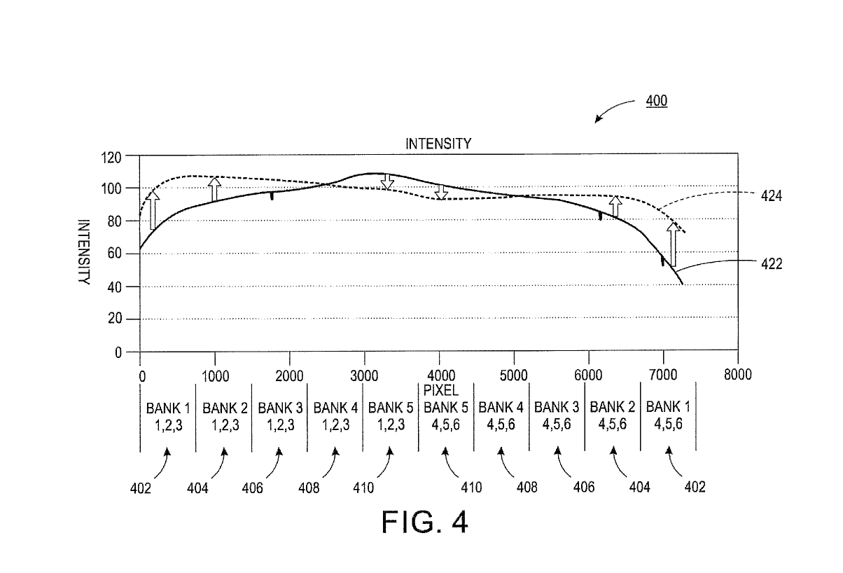

FIG. 4 illustrates an example graph 400 of an unadjusted light intensity profile 422 and an adjusted light intensity profile 424. In one embodiment, the LEDs 104 may be divided into a plurality of different banks of LEDs 402-410 that take advantage of the symmetry of the LED array 102 or optical system.

For example, referring back to FIG. 1, the LED array 102 may be symmetric about a center line or point 114. In other words, the LEDs 104 on one side of the center line 114 and the corresponding LEDs 104 on an opposite side of the center line 114 may have a similar light output. Said another way, the LED array 102 illumination profile may be substantially symmetrical around the center line 114. Said yet another way, the LED banks 402-410 may include groups of LEDs 104 that are not all adjacent to one another or next to one another. For example, bank 1 402 can include LEDs 104 that are on opposite ends of the LED array 102, as illustrated in FIG. 4. As a result, when an adjustment is made to the bank 1 402, each LED 104 on opposite ends of the LED array 102 within the bank 1 402 would be adjusted. The adjustment to each one of the LED banks 402-410 may be made via either a fixed mechanism or a dynamic mechanism, as described above with respect to FIG. 3.

In one embodiment, the arrangement of the banks of LEDs 402-410 may take advantage of the symmetry of the LED array 102 or optical system by electrically coupling the banks of LEDs 402-410 with LEDs 104 on both sides of the center line 114. As illustrated in FIG. 4, bank 1 402 may include three LEDs from a left side that are a first distance away from the center line 114 and three LEDs from a right side of the center line 114 that are the same first distance away from the center line as the three LEDs on the left side. Bank 2, 404 may include three LEDs from a left side at a second distance away from the center line 114 and three LEDs from a right side of the center line 114 that are the same second distance away from the center line, and so forth for bank 3 406, bank 4 408 and bank 5 410. As a result, each bank 402-410 may provide an ability to control the LEDs on opposite sides of the LED array 102 with a single control.

The design of FIG. 4 may improve upon further the design disclosed in FIG. 3 as the amount of circuitry needed is reduced. For example, rather than deploying 10 different banks of circuitry (e.g., the circuit 200 disclosed in FIG. 2), only 5 different banks of circuitry would be required by taking advantage of the symmetric properties of the LED array 102.

In addition, the amount of resolution for adjusting the light output of LEDs 104 may also be improved by taking advantage of the symmetric properties of the LED array 102 or optical system. For example, the LED array 102 may be configured to only allow for 5 independently controlled banks of LEDs 104. If the LED array 102 has 30 LEDs, then one option would be to have 5 banks that include 6 adjacent LEDs 104 in each one of the 5 banks (e.g., the arrangement illustrated in FIG. 3). However, by taking advantage of the symmetry, one embodiment of the present disclosure creates 5 independently controlled banks of LEDs 104 each having 3 adjacent LEDs on each side of the LED array (e.g., the arrangement illustrated in FIG. 4). Although each bank would control 6 LEDs, the resolution would improve to 3 LEDs on each side of the LED array 102 for each adjustment that is made.

Similar to the design illustrated in FIG. 3, the LED banks 402-410 may each be adjusted to either increase or decrease the amount of light output for the LEDs 104 within a respective LED bank 402-410. For example, the current delivered to the LEDs 104 in bank 1 402 may be increased to increase an amount of light output and the current delivered to the LEDs 104 in bank 5 410 may be decreased to decrease an amount of light output.

As a result, the embodiments of the present disclosure allow the LEDs 104 to be controlled to reduce variation across a light intensity profile of the LED array 102. In other words, the signal to noise ratio may be similar across the entire profile. This improves the signal to noise ratio across the entire image and reduces the illumination variation, bringing it into a narrower range for calibration.

It should be also noted that the present disclosure may not necessarily be adjusting the LED light intensity to achieve a certain level of uniform light intensity. Rather, the embodiments of the present disclosure adjust the LED light intensity, at any intensity level, such that the light collected by the sensor 110 is uniform across the LED array 102 to minimize the amount of image compensation that needs to be applied after the sensor 110.

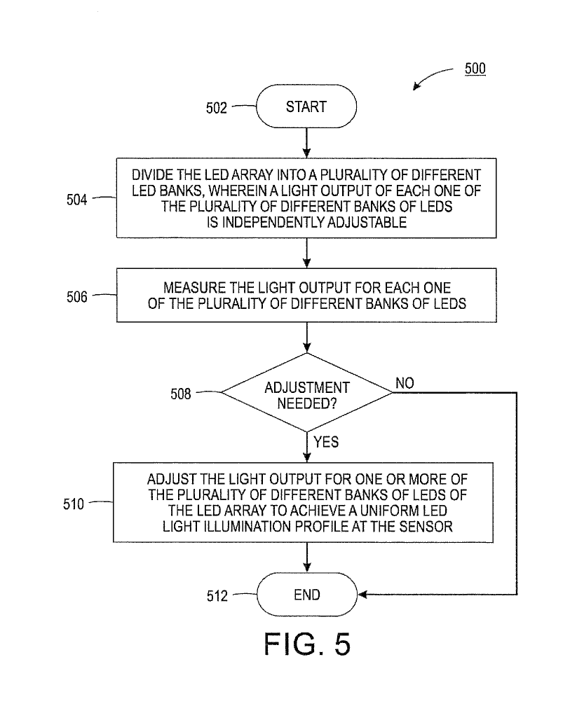

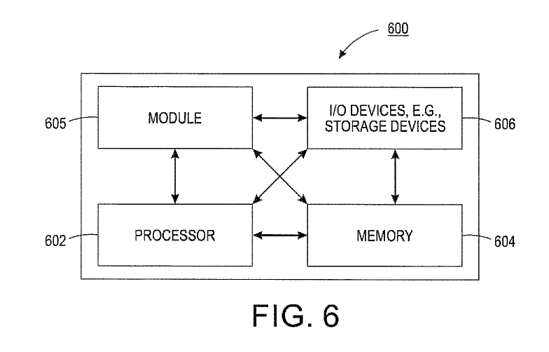

FIG. 5 illustrates a flowchart of a method 500 for adjusting LED light uniformity in an LED array. In one embodiment, one or more steps or operations of the method 500 may be performed by the controller 116 or a computer as illustrated in FIG. 6 and discussed below.

At step 502 the method 500 begins. At step 504, the method 500 divides the LED array into a plurality of different LED banks, wherein a light output of each one of the plurality of different banks of LEDs is independent adjustable. In one embodiment, the LED banks may include groups of LEDs that are on opposite sides of the LED array to take advantage of the symmetric properties of the LED array or optical system. In other words, the LED array or the illumination profile of the LED array may be substantially symmetrical around a center or point of the LED array and each one of the plurality of different banks of LEDs may include a group of LEDs on opposite sides of the center of the LED array.

At step 506, the method 500 measures the light output for each one of the plurality of different banks of LEDs. For example, a light intensity profile across the LED array may be obtained based upon the measured light output of each LED in the LED array.

At step 508, the method 500 determines if an adjustment is needed. For example, the measured light output may be averaged and the light output of each LED may be compared to the average to see if the light output of the LED is within a threshold level of the average. If the light output of the LED is within the threshold, then no adjustment may be needed and the method 500 may proceed to step 512.

However, if the difference of light output of the LED compared to the average light output of the LED array is above the threshold or greater than the threshold, then an adjustment may be needed. The step 508 may be repeated for each LED within the LED array.

If an adjustment is needed, the method 500 may proceed to step 510. At step 510, the method 500 may adjust the light output for one or more of the plurality of different banks of LEDs of the LED array to achieve a uniform LED light illumination profile at the sensor. For example, the ends of the LED array 102 may have a dramatic drop off in light intensity. As a result, a bank of the LED array that includes LEDs on both a left end and a right end of the LED array may be adjusted to increase the light intensity of the LEDs on the left end and the right end of the LED array. Notably, only a single bank is adjusted to change simultaneously the LEDs in a particular bank. In other words, each individual LED is not adjusted. In addition, the bank does not only include LEDs that are immediately adjacent to one another.

In one embodiment, the method 500 may adjust the light output for all LED banks that require an adjustment. The adjustment may be either an increase or a decrease.

The method 500 may then proceed to step 512. At step 512 the method 500 ends. In one embodiment, steps 502-512 may be run again for verification (or iteratively). Additionally, it may be possible to iterate between steps 506 and 510.

It should be noted that although not explicitly specified, one or more steps, functions, or operations of the method 500 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 5 that recite a determining operation, or involve a decision, do not necessarily require that both branches of the determining operation be practiced. In other words, one of the branches of the determining operation can be deemed as an optional step.

FIG. 6 depicts a high-level block diagram of a computer that can be transformed into a machine that is dedicated to perform the functions described herein. Notably, no computer or machine currently exists that performs the functions as described herein. As a result, the embodiments of the present disclosure improve the operation and functioning of the computer to dynamically adjust an LED light array to achieve LED light uniformity, as disclosed herein.

As depicted in FIG. 6, the computer 600 comprises one or more hardware processor elements 602 (e.g., a central processing unit (CPU), a microprocessor, or a multi-core processor), a memory 604, e.g., random access memory (RAM) and/or read only memory (ROM), a module 605 adjusting LED light uniformity in an LED array, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 605 for adjusting LED light uniformity in an LED array (e.g., a software program comprising computer-executable instructions) can be loaded into memory 604 and executed by hardware processor element 602 to implement the steps, functions or operations as discussed above in connection with the exemplary method 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for adjusting LED light uniformity in an LED array (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An input imaging system having a light emitting diode (LED) light illumination profile, comprising:
an LED array, wherein the LED array is divided into a plurality of different banks of LEDs, wherein a light output of each one of the plurality of different banks of LEDs is independently adjustable, wherein the LED light illumination profile is substantially symmetrical around a center, or a point, of the LED array and each one of the plurality of different banks of LEDs comprises a group of LEDs on opposite sides of the center, or the point, of the LED array;
an electrical device for adjusting the light output of the each one of the banks of LEDs coupled to each one of the plurality of different banks of LEDs to achieve a uniform LED light illumination profile;
a diffuser coupled to the LED array to scatter the light output towards a document;
a lens for collecting the light output that is reflected off of the document; and
a sensor coupled to the lens to receive the light output that is collected by the lens.

2. (canceled)

3. The input imaging system of claim 1, wherein the electrical device for adjusting comprises a fixed mechanism.

4. The input imaging system of claim 3, wherein the fixed mechanism comprises deploying a current resistor having a resistance value based on the light output of the each one of the banks of the LEDs to achieve the uniform LED light illumination profile.

5. The input imaging system of claim 1, wherein the electrical device for adjusting comprises a dynamic mechanism.

6. The input imaging system of claim 5, wherein the dynamic mechanism comprises a controller coupled to the sensor and the LED array, wherein the controller analyzes the light output of the each one of the plurality of different banks of LEDs received by the sensor and adjusts a current delivered to one or more of the plurality of different banks of LEDs based on the light output of the each one of the plurality of different banks of LEDs received by the sensor.

7. The input imaging system of claim 1, wherein the electrical device for adjusting adjusts a bank of LEDs of the plurality of different banks of LEDs that is on an end of the LED array to increase the light output.

8. The input imaging system of claim 1, wherein the electrical device for adjusting adjusts a bank of LEDs of the plurality of different banks of LEDs towards a center of the LED array to reduce the light output.

9. The input imaging system of claim 1, wherein each LED of the LED array requires at least 20 milliwatts of power or approximately 1 candela to generate the light output.

10. A method for adjusting LED light uniformity in an LED array, comprising:
dividing the LED array into a plurality of different LED banks, wherein a light output of each one of the plurality of different banks of LEDs is independently adjustable, wherein the LED light illumination profile is substantially symmetrical around a center, or a point, of the LED array and each one of the plurality of different banks of LEDs comprises a group of LEDs on opposite sides of the center, or the point, of the LED array;
measuring, by a processor, the light output for each one of the plurality of different banks of LEDs; and
adjusting, by the processor, the light output for one or more of the plurality of different banks of LEDs of the LED array to achieve a uniform LED light illumination profile at a sensor.

11. (canceled)

12. The method of claim 10, wherein the adjusting comprises adjusting an amount of current delivered to the one or more of the plurality of different banks of LEDs.

13. The method of claim 10, wherein the one or more of the plurality of different banks of LEDs comprise a bank of LEDs that comprises a group of LEDs on each end of the LED array.

14. The method of claim 13, wherein the adjusting comprises increasing the light output of the bank of LEDs that comprises the group of LEDs on each end of the LED array.

15. The method of claim 10, wherein the one or more of the plurality of different banks of LEDs comprise a bank of LEDs that comprises a group of LEDs towards a center of the LED array.

16. The method of claim 15, wherein the adjusting comprises decreasing the light output of the bank of LEDs that comprises the group of LEDs towards the center of the LED array.

17. The method of claim 10, wherein each LED of the LED array requires at least 20 milliwatts of power or approximately 1 candela to generate the light output.

18. An input imaging system having a light emitting diode (LED) light illumination profile, comprising:
an LED array, wherein the LED array is symmetrical around a center, or a point, of the LED array, wherein the LED array is divided into a plurality of different banks of LEDs, wherein each one of the plurality of different banks of LEDs comprises at least two groups of LEDs on opposite sides of the center of the LED array, wherein a light output of each one of the plurality of different banks of LEDs is independently adjustable;
an electrical device for adjusting a current delivered to the each one of the banks of LEDs coupled to each one of the plurality of different banks of LEDs to adjust the light output to minimize a signal-to-noise ratio across an image area illuminated by the LED array to achieve a uniform LED light illumination profile;
a diffuser coupled to the LED array to scatter the light output towards a document;
a lens for collecting the light output that is reflected off of the document; and
a charged coupled device (CCD) coupled to the lens to receive the light output that is collected by the lens.

19. The input imaging system of claim 18, wherein the electrical device for adjusting comprises a fixed mechanism comprising deploying a current resistor having a resistance value based on the light output of the each one of the banks of the LEDs to achieve the uniform LED light illumination profile.

20. The input imaging system of claim 18, wherein the electrical device for adjusting comprises a dynamic mechanism comprising a controller coupled to the CCD and the LED array, wherein the controller analyzes the light output of the each one of the plurality of different banks of LEDs received by the CCD and adjusts a current delivered to one or more of the plurality of different banks of LEDs based on the light output of the each one of the plurality of different banks of LEDs received by the CCD.
